(19) United States
(12) Patent Application Publication
(10) Pub. No.: US 2018/0230951 A1
(43) Pub. Date: Aug. 16, 2018

(54) TOOL FOR QUICK CONNECT FUEL CONNECTOR

(71) Applicant: Ford Motor Company, Dearborn, MI (US)

(72) Inventors: Hossein FIROOZGAN, Walled Lake, MI (US); Ali MANESHI, West Bloomfield, MI (US)

(21) Appl. No.: 15/433,317

(22) Filed: Feb. 15, 2017

(51) Int. Cl. F02M 37/00

(52) U.S. Cl. CPC F02M 37/0017; F02M 2200/8061

(57) ABSTRACT

A quick connect tool is configured to connect male and female ends of a quick connect fuel or oil connector of an automobile. The tool includes a pair of handles pivotally coupled to each other. The tool also includes a pair of arms having pockets configured to receive respective ends of a fuel-line coupling, the arms coupled to the handles via a linkage such that pivotal movement of the handles causes linear movement of the arms to force the ends into engagement. A sensor is configured to output a signal in response to the linear movement exceeding a threshold, indicating that the arms have translated linearly enough to cause a correct and sufficient fitting between the male and female ends.

### TECHNICAL FIELD

This disclosure generally relates to a tool for confirming the proper connection of a quick connect fuel or oil connector of an automobile.

### BACKGROUND

Quick connect couplings have been widely used in the automotive industry for many years. Although applicable in numerous applications, quick connect couplings are typically utilized in fuel systems such as port fuel direct injection (PFDI) engines. Typical quick connect couplings include a female type quick connector with a wide mouth that is connectable to and releasable from a male tube inserted therein.

### SUMMARY

According to one embodiment, a quick connect tool is provided. The tool is configured to connect first and second ends of a quick connect fuel or oil connector of an automobile. The tool includes a pair of handles pivotally coupled to each other. The tool also includes a pair of arms having pockets configured to receive respective ends of a fuel-line coupling, the arms coupled to the handles via a linkage such that pivotal movement of the handles causes linear movement of the arms to force the ends into engagement. The tool also includes a sensor configured to output a signal in response to the linear movement exceeding a threshold.

According to another embodiment, a tool for confirming proper connection of a quick connect fuel coupling is provided. The tool includes first and second handle members directly pivotally coupled to one another via a gearing arrangement. The tool also includes a pair of arms configured to couple to respective male and female ends of the fuel coupling. The tool also includes a proximity sensor configured to send a signal in response to at least a portion of the first and second handle members contacting each other. Compression of the handle members translates the arms linearly toward one another and a positive signal from the proximity sensor indicates the fuel coupling is properly connected.

According to yet another embodiment, a method of connecting a quick-connect fuel coupling includes first inserting ends of the coupling into respective receptacles that extend from a tool. The method includes pivotally rotating handles of the tool toward one another to linearly translate the ends into engagement until stops on the tool engage. Finally, the method includes receiving a notification that the stops engaged, indicating that the ends of the coupling are properly attached.

### BRIEF DESCRIPTION OF THE DRAWINGS

FIG. 1 is a side view of a typical quick connect fuel connector.

FIG. 2 is a perspective view of a tool for confirming proper seating of a quick connect fuel connector, according to one embodiment.

FIG. 3 is a front view of the tool, shown connected to a female portion of the quick connect fuel connector, according to one embodiment.

FIG. 4A is a schematic view of interior mechanics of the tool in its normally-open position, according to one embodiment.

FIG. 4B is a schematic view of the interior mechanics of the tool in its closed position, according to one embodiment.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

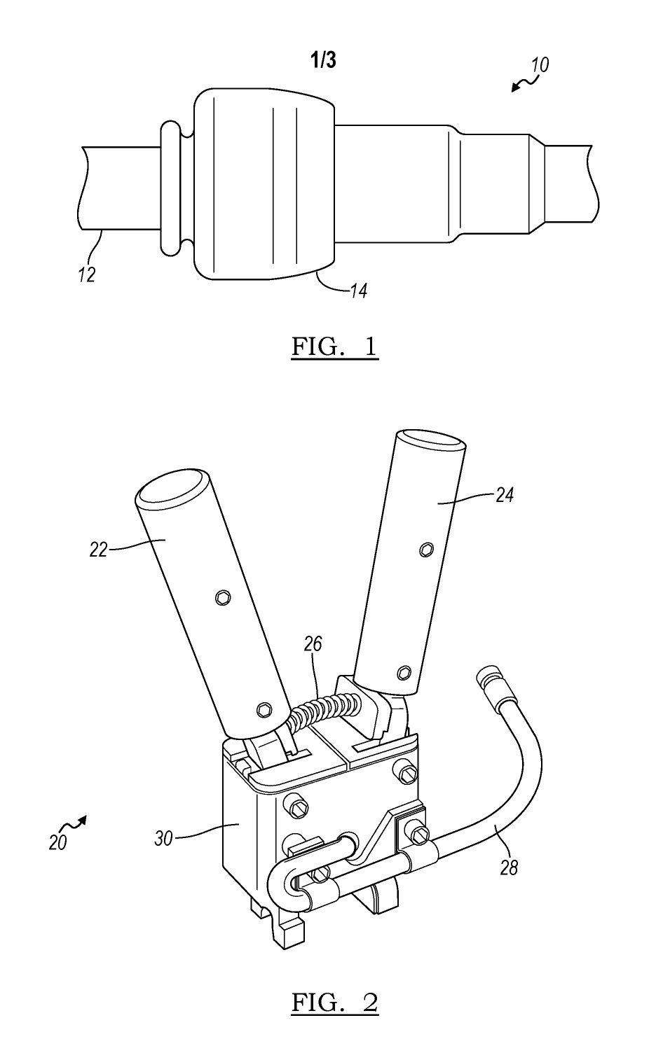

In fluid delivery systems, it is imperative that the quick connectors have their male and female portions properly coupled together. FIG. 1 shows a typical quick connect 10 in which a male end 12 is removably attached and fed into a female end 14. If the male end 12 is not inserted deep enough into the female end, a faulty connection could result. A faulty connection could enable an associated system to leak fluid or vapor. This can be particularly disadvantageous when the system is under pressure and the leaking connector expels the pressurized fluid. Moreover, current quick connect fuel connectors require redundant secondary latches which, in some cases, can be installed incorrectly and can be costly and, in some cases, does not package into the design space. Failure to fully seat the connector and properly latch the installation could result in fuel leak at vehicle operation, which could lead to repairs.

Therefore, according to various embodiments of this disclosure, a tool is disclosed that quickly and easily confirms the seating of the quick connect fuel connector.

FIG. 2 illustrates a tool 20 for confirming the seating and connection of the quick connect fuel connector, such as the quick connect fuel connector 10 shown in FIG. 1. The tool includes a first handle 22 and a second handle 24 for grasping by a user. The handles 22, 24 are separated by a spring 26 which maintains the tool in a normally-open position. In use (which will be further described below), the user presses the handles 22, 24 closer together, compressing the spring and pressing the tool toward its closed position. The tool also has a power cable or wire 28 to connect the tool 20 to a power source to power a proximity sensor, which is described below.

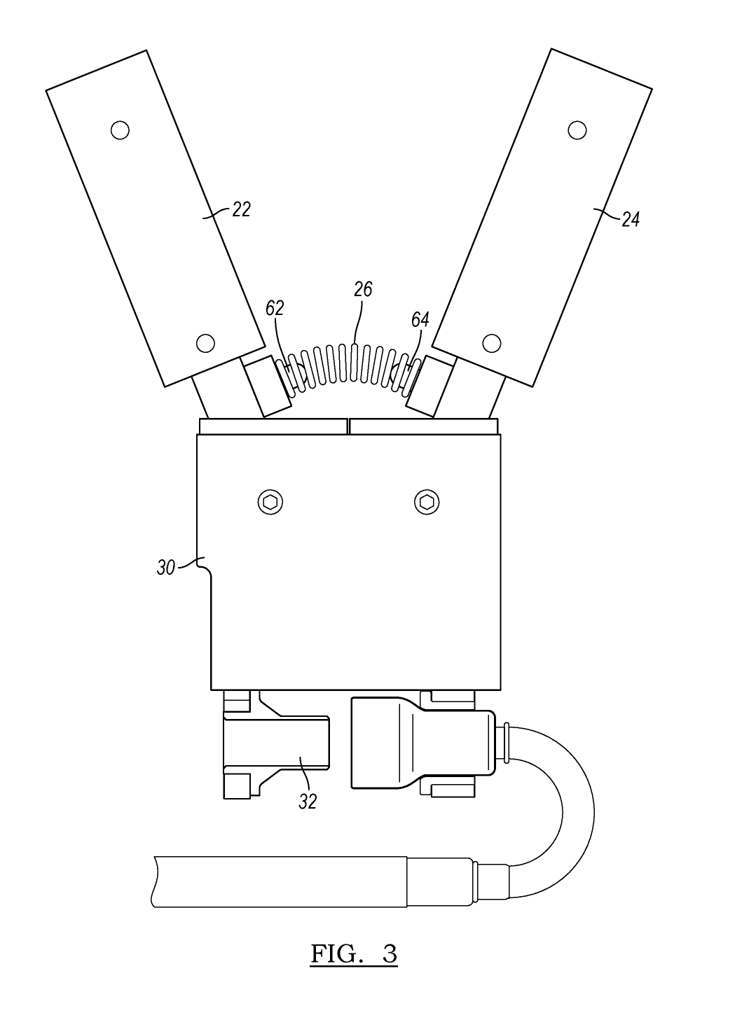

The tool 20 is shown in FIG. 3 with the female half of the quick connect fuel connector 10 attached thereto. The tool 20 has a housing 30 with a pair of arms 32, also referred to as contact tooling or contact tools, extending downward therefrom. The arms 32 can be semi-cylindrical with an interior diameter sized to snugly receive an outer diameter of both the male and female ends of the quick connect fuel connector. As shown here, the female end of the connector is placed on the right arm, and the male end of the connector would be placed on the left arm and inserted into the female end.

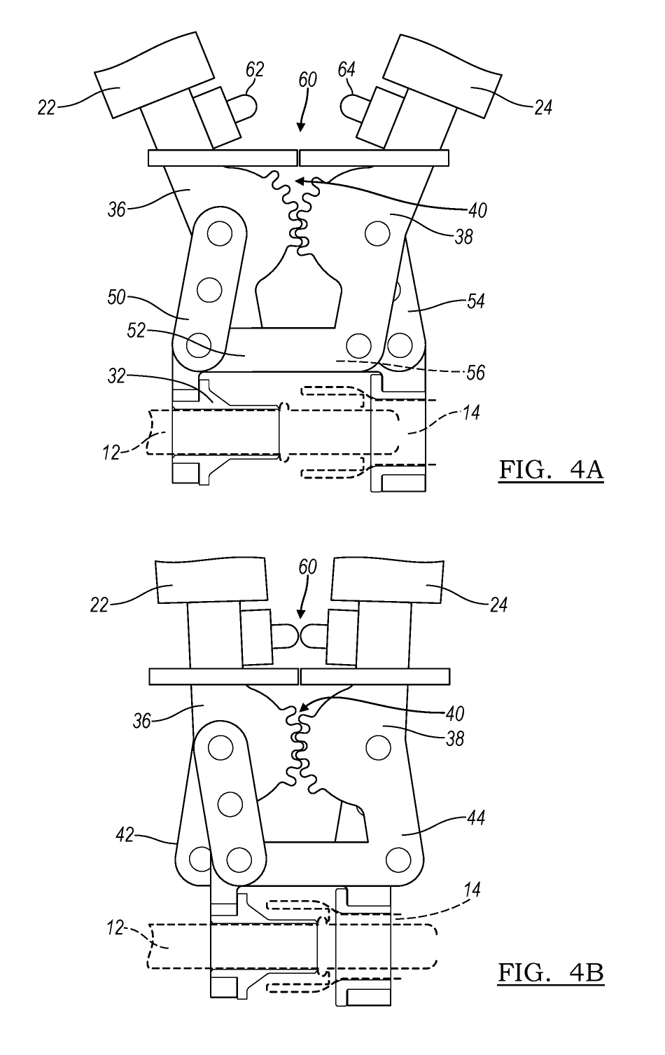

FIGS. 4A-4B show the interior mechanisms within the housing 30 of the tool 20. The first handle 22 has, or is connected to, a first extension member 36; the second handle 24 has, or is connected to, a second extension member 38. The first and second extension members 36, 38 each include rounded regions defining sprocket members that provide a sprocket or gearing arrangement 40. The gearing arrangement 40 facilitates a rotatable coupling between the two handles which enables the handles to be timed together.

The first extension member 36 also terminates in an end portion 42 which is integrally formed or fixed relative thereto, and the second extension member 38 terminates in an end portion 44 which is integrally formed or fixed relative thereto. The end portions of each extension member 36, 38 are not connected directly to one another, but are connected to a four-bar linkage, as described below.

The first extension member 36 is pivotally connected to a first link or bar 50, which is, in turn, pivotally connected to a second link or bar 52. The second bar 52 is pivotally connected to the second extension member 38. Likewise, the second extension member 38 is pivotally connected to a third link or bar 54, which is, in turn, pivotally connected to a fourth link or bar 56. The fourth bar 56 is pivotally connected to the first extension member 36. This four-bar linkage converts pivotal movement of the handles at the gearing arrangement 40 into linear movement of the second and fourth bars 52, 56. The second bar 52 is connected to one of the semi-cylindrical arms 32, and the fourth bar 56 is connected to the other of the semi-cylindrical arms 32. Thus, when the second and fourth bars 52, 56 are moved linearly, so too are the arms 32. When the handles are in their open position (FIG. 4A), the arms are relatively spaced apart; when the handles are compressed to their closed position (FIG. 4B), the arms are moved closer together via the four-bar linkage.

The tool 20 is provided with a proximity switch, also referred to as a touch switch. The switch is not illustrated here, but can be a type of switch that provides a positive signal when the two fixed portions 62, 64 of a hard stop 60 touch one another. The switch may be located within the cover 30 adjacent or within one or both of the fixed portions 62, 64. When the two portions 62, 64 of the hard stop 60 touch each other, a positive signal is provided to a controller (not shown), indicating that the handles have been compressed far enough and the male portion of the quick connect fuel connector is proper seated and inserted deep enough into the female portion. This assures the fuel connector is properly connected. The controller can initiate visual or audible notifications in response to receiving the positive signal.

In one embodiment, the fixed portions 62, 64 are at least partially disposed within the spring 26.

In operation, the user places the arms 32 of the tool 20 about the male and female quick connect coupling. The user then presses the handles toward each other. This causes the four-bar linkage to linearly translate the arms and slide the arms relative to the quick connect coupling. The handles are pressed until the two portions 62, 64 of the hard stop 60 contact one another, indicating that the arms 32 have translated a sufficient linear distance to cause an adequate coupling of the male and female ends of the quick connect fuel connector. When the two portions 62, 64 contact one another, the proximity sensor sends a positive signal. This indicates that the handles and their associated mechanisms in the housing have moved far enough such that the quick connect coupling is properly seated. In other words, the proximity sensor sends the signal in response to the arms moving a linear distance that exceeds a threshold.

The Figures and description provided above provide one embodiment of a tool having handles directly coupled to each other (e.g., via a sprocket), and indirectly coupled to one another (e.g., via a four-bar linkage) such that relative movement of the handles causes linear relative movement of arms that receive male and female ends of a quick connect fuel coupling. One embodiment is also provided in which a sensor is configured to send a signal (e.g., when stops contact one another) indicating that the handles have been rotated relative to each other a sufficient distance (and therefore the arms have translated linearly a sufficient distance) to cause a proper engagement and fitting of the ends of the quick connect fuel coupling. However, the Figures and description above are but one embodiment, and it should be understood that the mechanics can be altered slightly by a skilled artisan to achieve the same end result. Those embodiments are also contemplated as part of this disclosure.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A quick connect tool, comprising:
a pair of handles pivotally coupled to each other;
a pair of arms having pockets configured to receive respective ends of a fuel-line coupling, the arms coupled to the handles via a linkage such that pivotal movement of the handles causes linear movement of the arms to force the ends into engagement; and
a sensor configured to output a signal in response to the linear movement exceeding a threshold.

2. The tool of claim 1, further comprising a pair of stops on the handles that contact each other to limit further pivotal movement of the handles.

3. The tool of claim 2, wherein the sensor is configured to output the signal in response to the pair of stops contacting each other.

4. The tool of claim 2, wherein the stops are disposed within a common spring that biases the handles away from one another.

5. The tool of claim 1, wherein the pockets are partial-cylindrical in shape and include an inner diameter sized to receive an outer diameter of the ends of the fuel-line coupling.

6. The tool of claim 1, wherein the handles are indirectly pivotally coupled to one another via a linkage.

7. The tool of claim 6, wherein the pair of handles includes a first handle and a second handle, and the linkage includes
a first link pivotally coupled to the first handle,
a second link pivotally coupled to the first link and the second handle,
a third link pivotally coupled to the second handle, and
a fourth link pivotally coupled to the third link and the first handle.

8. The tool of claim 6, wherein the arms extend from the linkage.

9. The tool of claim 1, wherein the handles are directly pivotally coupled to one another via a gearing arrangement enabling pivotal movement of the handles to be timed together.

10. A tool for confirming proper connection of a quick connect fuel coupling, comprising:
first and second handle members directly pivotally coupled to one another via a gearing arrangement;
a pair of arms configured to couple to respective male and female ends of the fuel coupling; and
a proximity sensor configured to send a signal in response to at least a portion of the first and second handle members contacting each other;
wherein compression of the handle members translates the arms linearly toward one another and a positive signal from the proximity sensor indicates the fuel coupling is properly connected.

11. The tool of claim 10, wherein the first and second handle members are indirectly coupled to one another via a four-bar linkage.

12. The tool of claim 11, wherein the four-bar linkage includes
a first link pivotally coupled to the first handle,
a second link pivotally coupled to the first link and the second handle,
a third link pivotally coupled to the second handle, and
a fourth link pivotally coupled to the third link and the first handle.

13. The tool of claim 11, wherein the arms extend from the four-bar linkage.

14. The tool of claim 10, further comprising a stop between the handles that limits pivotal movement of the handles toward one another.

15. The tool of claim 10, further comprising a spring between the handles biasing the handles away from one another.

16. A method of connecting a quick-connect fuel coupling, comprising:
inserting ends of the coupling into respective receptacles that extend from a tool;
pivotally rotating handles of the tool toward one another to linearly translate the ends into engagement until stops on the tool engage; and
receiving a notification that the stops engaged, indicating that the ends of the coupling are properly attached.

17. The method of claim 16, wherein the pivotally rotating causes linear translation of the receptacles.

18. The method of claim 16, wherein the pivotally rotating includes rotating the handles with respect to one another about a gearing arrangement.

19. The method of claim 16, further comprising releasing the handles and allowing the handles to return to a spring-biased, separated position.
